(19) United States
(12) Patent Application Publication
(10) Pub. No.: US 2007/0206314 A1
(43) Pub. Date: Sep. 6, 2007

(54) Methods and apparatus for controlling read/write duty cycle in a data storage device based on thermal inputs

(76) Inventors: Jeffrey V. DeRosa, Burlington, MA (US); Randy S. Cohen, Worcester, MA (US)

Correspondence Address: David C. Hall;Myers Bigel Sibley & Sajovec, P. A., P. O. Box 37428, Raleigh, NC, 27627, US

(21) Appl. No.: 11/522,716

(22) Filed: Sep. 18, 2006

Related U.S. Application Data
(60) Provisional application No. 60/779,288, filed on Mar. 3, 2006.

(51) Int. Cl. G11B 21/02; G11B 19/02

(52) U.S. Cl. 360/75; 360/69

(57) ABSTRACT

Methods of controlling an I/O operation of a disk drive include determining a temperature associated with the disk drive, comparing the determined temperature to a temperature threshold, setting a duty cycle limit for the I/O operation in response to the determined temperature exceeding the temperature threshold, and performing the I/O operation subject to the duty cycle limit. The I/O operation may include a data write and/or a data read operation. Disk drives configured to control I/O operations based on temperatures are also disclosed.

### RELATED APPLICATION

This application claims the benefit of and priority to U.S. Provisional Patent Application No. 60/779,288 titled “THERMAL READ/WRITE GOVERNOR ALGORITHM”, filed Mar. 3, 2006, the disclosure of which is hereby incorporated herein by reference as if set forth in its entirety.

### FIELD OF THE INVENTION

The present invention generally relates to digital data storage devices and, more particularly, to methods, apparatus, and computer program products for controlling an input/output (I/O) operation in a disk drive based on temperature measurements.

### BACKGROUND OF THE INVENTION

Disk drives are digital data storage devices which can enable users of computer systems to store and retrieve large amounts of data in a fast and efficient manner. A typical disk drive includes a plurality of magnetic recording disks which are mounted to a rotatable hub of a spindle motor and rotated at a high speed. An array of read/write transducers is disposed adjacent surfaces of the disks to transfer data between the disks and a host computer. The transducers can be radially positioned over the disks by a rotary actuator and a closed loop, digital servo system, and can fly proximate the surfaces of the disks upon air bearings.

A plurality of nominally concentric tracks can be defined on each disk surface. A preamp and driver circuit generates write currents that are used by the transducer to selectively magnetize the tracks during a data write operation and amplifies read signals detected by the transducer from the selective magnetization of the tracks during a data read operation. A read/write channel and interface circuit are connected to the preamp and driver circuit to transfer the data between the disks and the host computer.

The servo system can operate in two primary modes: seeking and track following. During a seek, a selected transducer is moved from an initial track to a destination track on the corresponding disk surface. The servo system applies current to an actuator coil to first accelerate and then decelerate the transducer toward the destination track.

During the seek, the servo system may sequentially measure the actual velocity of the transducer and adjust the current in relation to velocity error (i.e., the difference between the actual velocity and a target velocity). As the transducer approaches the destination track, the servo system initiates a settle mode to bring the transducer to rest over the destination track within a selected settle threshold, such as a percentage of the track width from track center. Thereafter, the servo system enters the track following mode wherein the transducer is nominally maintained over the center of the destination track until another seek is performed.

As access speeds and storage capacities of disk drives have increased, the distance between the transducers and the disk media of a disk drive has been reduced. As a result, slight variations in the positioning or dimensions of the transducers and/or of the disk media can cause elements of the heads to make contact with the disk media. For example, such a collision can be caused by protrusion of the pole tips of the write portion of a read/write head, a phenomenon referred to as pole tip protrusion (PTP).

As will be appreciated, a disk drive is primarily utilized to transfer data between the tracks of the disks and the host computer. Such data transfer operations usually cannot occur during a seek, but rather require the drive to be in track following mode. The ambient temperature as well as any electric current that is applied to the transducers during a write operation in track following mode may cause the transducer element to become heated, which may contribute to PTP. If PTP causes the transducer element to contact the disk surface, data may be lost and/or the transducer and/or disk surface may be damaged. Contact between the transducers and the disk surface may also cause more heating of the transducers, which may result in even more PTP.

One approach to mitigating the effect of PTP is to raise the flying height of the transducers in order to avoid contact between the transducers and the disk surface. However, raising the flying height of the transducers may not be effective in disk drives having high density storage, since raising the flying height of the transducers may reduce the density at which data may be written to and/or read from a disk.

Conventional disk drives include circuitry configured to shut the disk drive down if a temperature sensed by a temperature sensor on the disk drive exceeds a predetermined threshold. However, such a shutdown is usually performed only as a last resort, as it may lead to loss of data and/or may prevent access to and/or storage of mission-critical data.

### SUMMARY

Some embodiments of the invention provide methods of regulating an I/O operation of a disk drive. The methods include measuring and/or estimating a temperature associated with the disk drive, comparing the determined temperature to a temperature threshold, setting a duty cycle limit for the I/O operation in response to the determined temperature exceeding the temperature threshold, and performing the I/O operation subject to the duty cycle limit. The I/O operation may include a data write and/or a data read operation.

Setting the duty cycle limit may include setting the duty cycle limit to a value associated with the temperature threshold. In some embodiments, setting the duty cycle limit may include setting the duty cycle limit to a value based on the amount by which the determined temperature exceeds the temperature threshold.

Setting the duty cycle limit for the I/O operation may include decreasing a duty cycle limit in response to the determined temperature exceeding the temperature threshold.

The methods may further include after performing the I/O operation, detecting a second temperature associated with the disk drive, and increasing the duty cycle limit in response to the second temperature being less than the temperature threshold.

Performing the I/O operation using the duty cycle limit may include performing the I/O operation using a transducer for a first number of wedges, and then resting the transducer for a second number of wedges. The second number of wedges may be varied in response to the comparison.

Performing the I/O operation using the duty cycle limit may include performing the I/O operation using a transducer for a first period of time, and then resting the transducer for a second period of time.

The temperature threshold may be a first temperature threshold, and the methods may further include comparing the measured temperature to a second temperature threshold in response to the measured temperature being less than the first temperature threshold. The temperature threshold may be reduced to a next lower temperature threshold in response to the measured temperature being less than the second temperature threshold. The methods may further include increasing the duty cycle limit in response to the measured temperature being less than the second temperature threshold. The second temperature threshold may be the next lower temperature threshold from the first temperature threshold and/or may be a lower temperature threshold than the next lower temperature threshold.

A disk drive according to some embodiments of the invention includes a temperature sensor configured to measure a temperature associated with the disk drive and a controller coupled to the sensor and configured to determine a temperature of a read/write transducer of the disk drive in response to the measured temperature, to compare the determined temperature to a temperature threshold, to set a duty cycle limit for an I/O operation in response to the determined temperature exceeding the temperature threshold, and to perform the I/O operation subject to the duty cycle limit. The controller may be further configured to estimate a temperature differential to correct for differences between a the measured temperature and an actual temperature of the read/write transducer.

The controller may be further configured to set the duty cycle limit to a value associated with the temperature threshold. In some embodiments, the controller may be further configured to set the duty cycle limit to a value based on the amount by which the determined temperature exceeds the temperature threshold. The controller may be further configured to decrease the duty cycle limit in response to the determined temperature exceeding the temperature threshold.

The controller may be further configured to, after performing the I/O operation, detect a second temperature associated with the disk drive, and to increase the duty cycle limit in response to the second temperature being less than the temperature threshold. The controller may also be configured to adjust the duty cycle as a function of the duration of the I/O operation. For example, the controller may decrease the duty cycle as the length of the I/O operation increases.

The controller may be further configured to perform the I/O operation using a transducer for a first number of wedges, and then to rest the transducer for a second number of wedges. The controller may be further configured to vary the second number of wedges in response to the comparison.

The controller may be further configured to perform the I/O operation using a transducer for a first period of time, and then to rest the transducer for a second period of time.

The controller may be further configured to compare the determined temperature to a next lower temperature threshold in response to the determined temperature being less than the threshold temperature. The controller may be further configured to reduce the threshold temperature to the next lower threshold temperature in response to the determined temperature being less than the next lower threshold temperature. The controller may be further configured to increase the duty cycle limit in response to the determined temperature being less than the next lower threshold temperature.

### BRIEF DESCRIPTION OF THE DRAWINGS

FIG. 1 is a block diagram of an exemplary computer system that includes a disk drive.

FIG. 2 is a diagram of an exemplary head disk assembly of the disk drive.

FIG. 3 is a block diagram of the drive electronics of the disk drive according to some embodiments of the present invention.

FIG. 4 is a top view of a conventional disk and illustrates tracks and sectors, with each of the sectors being divided into a servo sector and a data sector.

FIG. 5 is a schematic diagram of a read/write head and associated disk media of a disk drive according to some embodiments of the present invention.

FIG. 6 is a flowchart showing operations for adjusting a duty cycle limit in response to a temperature measurement according to some embodiments of the invention.

FIG. 7 is a graph of duty cycle versus temperature in accordance with some embodiments of the invention.

FIG. 8 is a flowchart showing operations for adjusting a duty cycle limit in response to a temperature measurement according to further embodiments of the invention.

### DETAILED DESCRIPTION OF EMBODIMENTS OF THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions. As used herein the term “and/or” includes any and all combinations of one or more of the associated listed items.

The present invention may be embodied as apparatus, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The present invention is described below with reference to block diagrams and/or operational illustrations of apparatus, methods, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

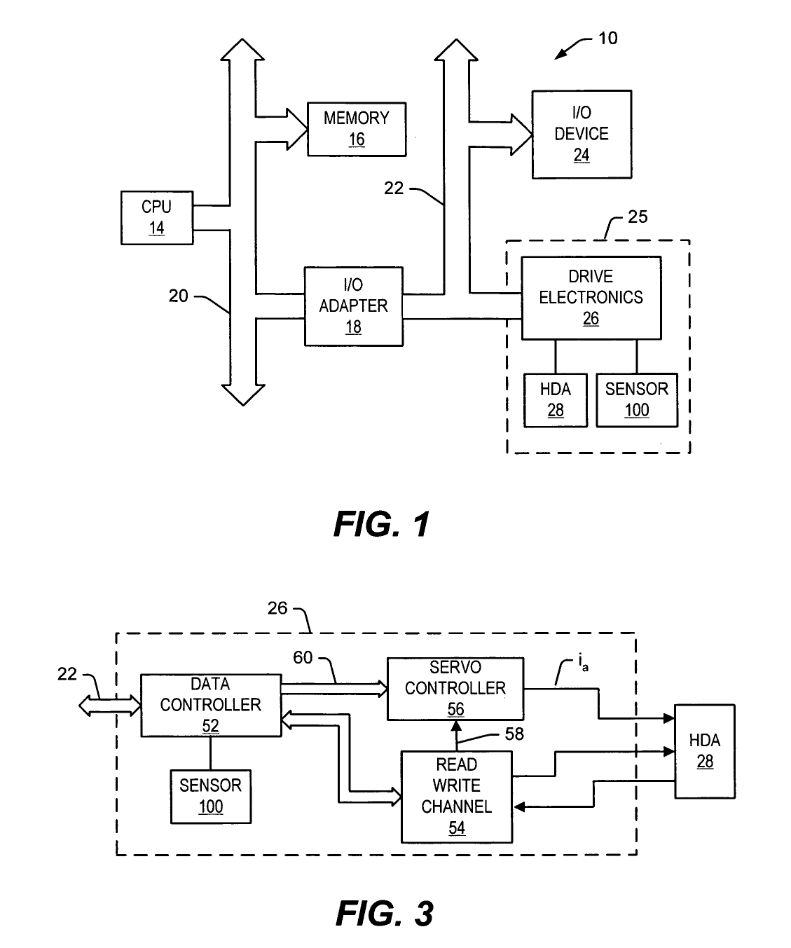

Referring to FIG. 1, an exemplary computer system 10 is shown that includes a central processing unit (“CPU”) 14, a main memory 16, and I/O bus adapter 18, all interconnected by a system bus 20. Coupled to the I/O bus adapter 18 is I/O bus 22, that may be, for example, a small computer system interconnect (SCSI) bus, firewire bus, and/or a universal serial bus. The I/O bus 22 supports various peripheral devices 24 and a data storage unit such as a disk drive 25. The disk drive 25 includes drive electronics 26 and a head disk assembly 28 (“HDA”). The disk drive 25 also includes one or more temperature sensors 100 configured to measure a temperature associated with the disk drive 25. The temperature sensor(s) 100 may be mounted within the case of the hard drive, and may be mounted, for example, on the printed circuit board assembly (PCBA) of the hard drive 25 and/or on the HDA of the disk drive 25. The temperature sensor(s) 100 may be mounted at other locations within the disk drive 25. The measured temperature may include, for example, the temperature within the case of the disk drive, the ambient temperature of the environment in which the disk drive is operated, a temperature sensed at the PCBA, and/or the temperature of another component of the disk drive.

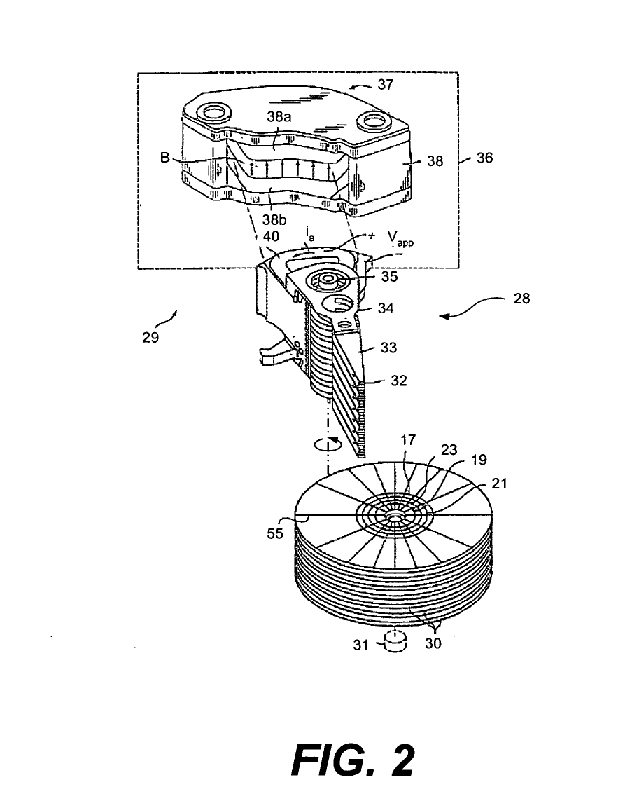

Referring to FIG. 2, an exemplary embodiment of the HDA 28 of FIG. 1 is shown that includes an actuator 29 and disks 30 that can be rotated by a spindle motor 31. Data can be stored on the disks 30 in concentric circular data tracks 17. The data can be written and read from the disks 30 via magnetic read/write heads 32 which include transducers attached to flexible load beams 33 extending from actuator arms 34. The actuator arms 34 pivot about point 35 to move the load beams 33 in a radial direction over the storage surfaces of the disks 30 from an initial track 19 towards a target track 21 shown in FIG. 2 by example. At the target track 21, the magnetic read/write heads 32 can read from and/or write data on the disks 30. A motor 36 controls the radial movement of the actuator arms 34 in proportion to an input actuator current iₐ. Although the disks 30 are described as magnetic disks for purposes of illustration, the disks 30 may alternatively be optical disks or any other type of storage disk which can have data storage tracks defined on one or both of its storage surfaces.

The exemplary motor 36 can include a magnet 37 containing two plates 38a, 38b coupled together via a pair of sidewalls to form a flat toroidal shaped member 38. A wire coil 40 is disposed between the two plates 38a and 38b. The magnet 37 may generate a constant magnetic field B between the plates 38a and 38b. When the input actuator current iₐ is induced in the coil 40 disposed in the magnetic field B, a torque is produced on the actuator arms 34 resulting in radial motion of the arms 34 about pivot point 35. The polarity of the input actuator current iₐ determines the direction of radial motion of the actuator arms 34. It will be appreciated, however, that a disk drive may use other methods to position the read/write transducers over the disk media.

Referring to FIG. 3, the drive electronics 26 (FIG. 1) includes a data controller 52, a read/write channel 54, and a servo controller 56. A data transfer initiated by the CPU 14 to the disk drive 25 may involve, for example, a DMA transfer of data from the memory 16 onto the system bus 20 (FIG. 1). Data from the system bus 20 are transferred by the I/O adapter 18 onto the I/O bus 22. The data are read from the I/O bus 22 by the data controller 52, which formats the data into blocks with the appropriate header information and transfers the digital data to the read/write channel 54. The temperature sensor 100 may be coupled to the data controller 52. The data controller 52 may control an I/O operation of the disk drive 25 in response to a temperature measurement provided by the temperature sensor 100.

The read/write channel 54 can operate in a conventional manner to convert data between the digital form used by the data controller 52 and the analog form used by the read/write heads 32. For the transfer from the CPU 14 to the HDA 28, the read/write channel 54 converts the data to an analog form suitable for writing by a read/write head 32 to the HDA 28. The read/write channel 54 also provides servo positional information read from the HDA 28 to the servo controller 56 on lines 58. For example, the concentric data tracks 17 on the storage surface of a data disk 30 can be broken up and divided into segments by a multiplicity of regularly spaced apart embedded servo sectors 55 (FIG. 2). Each servo sector 55 can include transducer location information such as a track identification field and data block address, for identifying the track and data block, and burst fields to provide servo fine location information. The transducer location information can be used to detect the location of the read/write head 32 in relation to that track and data block within the track. The transducer location information is induced into the read/write head 32, converted from analog signals to digital data in the read/write channel 54, and transferred to the servo controller 56. The servo controller 56 can use the transducer location information for performing seek and tracking operations of the read/write head 32 over the disk tracks 17.

The data controller 52 also provides data that identifies the target track location and the addressed data block on lines 60 to the servo controller 56. The time to perform a seek from between an initial track to a target track is typically known as “seek time”. The servo controller 56 generates a current command that is converted into the input actuator current iₐ, and provided to the actuator 29 to radially move the read/write head 32 across the disk 30. The seek time is thereby dependent on the magnitude of the current command.

Once the read/write head 32 has reached the target track 17, the time required to rotate the disk 30 to a desired sector to perform a particular data access can be referred to as “rotational latency time,” or, more succinctly, “rotational latency.” The rotational latency can be the time required to rotate from a current position to a desired position on the disk 30. Thus, the rotational latency may be as great as the time required for one revolution of the disk 30. The rotational latency is dependent on the angular velocity of the disk 30, which is usually expressed in revolutions per minute (RPM). Generally, the total time to access an addressed data block on the disk 30 is about equal to the sum of the seek time, the rotational latency, and the time required to read or write the data.

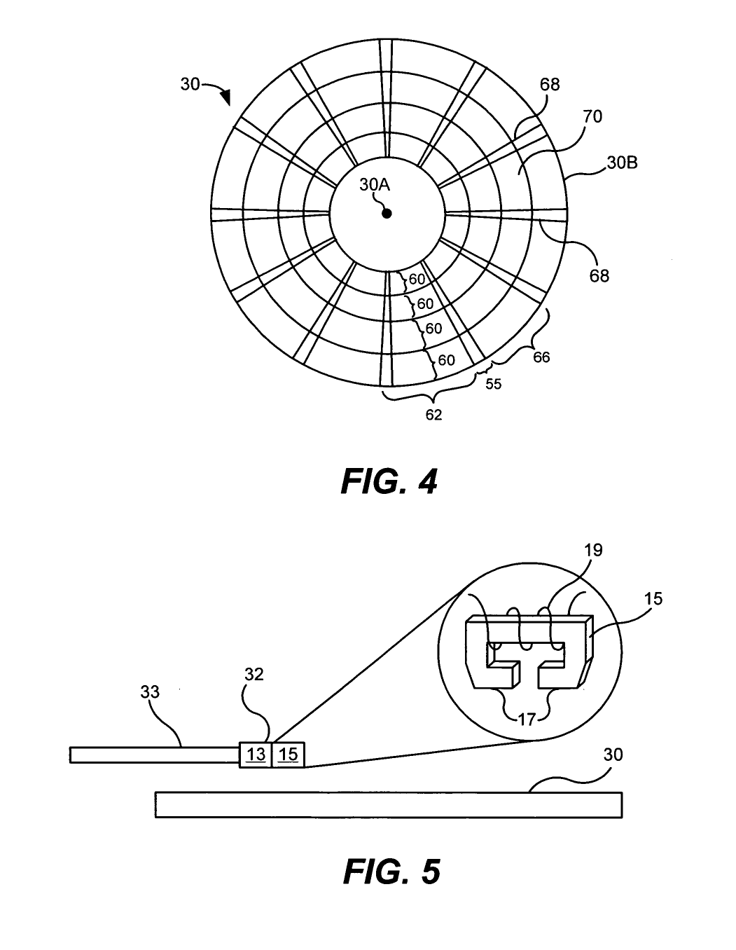

FIG. 4 further illustrates one of the disks 30. Data is stored on the disk 30 within a number of concentric tracks 60 (or cylinders). Each track is divided into a plurality of radially extending sectors 62 on the disk 30. Each sector 62 is further divided into a servo sector 55 and a data sector 66. The servo sectors 55 of the disk 30 are used to, among other things, accurately position the read/write heads 32 so that data can be properly written onto and read from the disk 30. The data sectors 66 are where non-servo related data (i.e., user data) is stored and retrieved. Such data, upon proper conditions, may be overwritten.

To accurately write data to and read data from the data sectors 66 of the disk 30, it is desirable to maintain the read/write heads 32 at a relatively fixed position with respect to a centerline of a designated track 60 during writing and reading operations (called a track following operation). To assist in controlling the position of the read/write heads 32 relative to the tracks 60, the servo sectors 55 contain, among other things, servo information in the form of servo burst patterns that include one or more groups of servo bursts, as is well-known in the art.

As can be seen from FIG. 4, the servo sectors 55 in adjacent tracks 60 form a plurality of “spokes” 68 extending generally from the center 30A of the disk 30 to the outer circumferential edge 30B of the disk 30. The spokes 68 generally define wedges 70 therebetween that include adjacent data sectors 66 that extend generally from the center 30A of the disk 30 to the outer circumferential edge 30B of the disk 30.

Referring now to FIG. 5, a read/write head 32 is shown in relation to a disk 30. As noted above, a disk drive may include a stack of disks 30. A different transducer head 32 may be provided for each side of a disk 30. Each transducer head 32 may include a read element 13 and a write element 15. In some embodiments, a traditional U-shaped head is used for writing data onto the disk 30 while a magneto-resistive (MR) read element is used for reading data from the disk 30. FIG. 5 includes an enlarged portion which shows a write element 15 including a pair of magnetic pole tips 17. The write element 15 may include, for example, a U-shaped head made of a conductive material (however, other geometries for the write element 15 are possible). The U-shaped member is wrapped with a coil of wire 19. A magnetic field is generated and transferred to the disk media in response to electric write signals that are passed through the coil 19. By changing the polarity of the electric current passed through the coil 19, the polarity of the field generated is also changed. The pattern of magnetic polarity transitions magnetize the surface of the disk 30 in a pattern which is a function of the transitions and which represents an encoded version of the data stored on the disk media.

The poles 17 of the write element 15 are positioned very close to the surface the of disk 30, and are maintained at a distance from the surface of the disk 30 by an air bearing. The disk drive 25 may also incorporate a control mechanism known as “fly height adjust” to further regulate this mechanical spacing. If there is contact between the tips of the write element 15 and the disk 30, or if the distance between the surface of the disk 30 and the pole tips 17 becomes unacceptably small, problems can arise with the disk 30 and/or the transducer head 32. For example, the transducer head 32 or the disk media can be damaged, and errors can be encountered when retrieving the data and reading the data from the disk media.

Such contact between the pole tips 17 and the disk 30 may occur when there is pole tip protrusion. Pole tip protrusion (PTP) can occur during data writing, which may cause thermal expansion of the pole tips 17 due, for example, to the combined effects of eddy current heating and coil heating. Such PTP phenomena can cause problems while writing data onto the disk media, such as damaging the disk surface, contaminating the transducer, eroding the pole tip 17 due to “machining” which may occur when the pole tip 17 contacts the disk surface, and/or causing loss of data written during low fly height. These effects may also cause drive failure.

According to some embodiments of the invention, when a temperature associated with the disk drive exceeds a first threshold level, a duty cycle of an I/O operation, such as a read operation and/or a write operation, is reduced until the temperature falls below a second threshold value that may be less than or equal to the first threshold value. The duty cycle of an I/O operation refers to the amount of time that the I/O operation is performed relative to a predetermined time frame. The time frame may be stated in terms of time units (e.g. milliseconds) and/or in terms of distance on a disk drive spinning at a predetermined rotational speed (e.g. the number of spokes/wedges that pass the transducer head).

In particular, an I/O operation may be performed for a first number of wedges and then the read/write head 32 may be rested for a second number of wedges. The first number of wedges divided by the sum of the first number of wedges and the second number of wedges may be less than or equal to the desired duty cycle limit. In some embodiments, following a wedge in which an I/O operation is performed, the write head may be rested for a number of consecutive wedges necessary in order to obtain the desired duty cycle limit. For example, if a write operation has a duty cycle of 20%, then after the write operation is performed during one wedge, the write head may be rested (i.e. not performing a write operation) for four consecutive wedges.

In other embodiments, a timer may be used to limit the duty cycle of an I/O operation. In particular, an I/O operation may be performed for a first period of time and then the read/write head 32 may be rested for a second period of time. The first period of time divided by the sum of the first period of time and the second period of time may be less than or equal to the desired duty cycle limit.

Multiple threshold values and/or multiple duty cycle limits corresponding to the threshold values may be used to progressively reduce the duty cycle of an I/O operation as the temperature associated with the disk drive increases. Similarly, the duty cycle of an I/O operation may be progressively increased as the temperature falls.

In some embodiments, after an I/O operation has been performed for a first period of time, a software delay may be invoked to prevent the data controller 52 from continuing the I/O operation and/or performing a subsequent I/O operation until a sufficient period of time has passed such that the duty cycle limit has been satisfied. In such cases, it may be desirable to disable software timeout counters that may otherwise be triggered as a result of the delay.

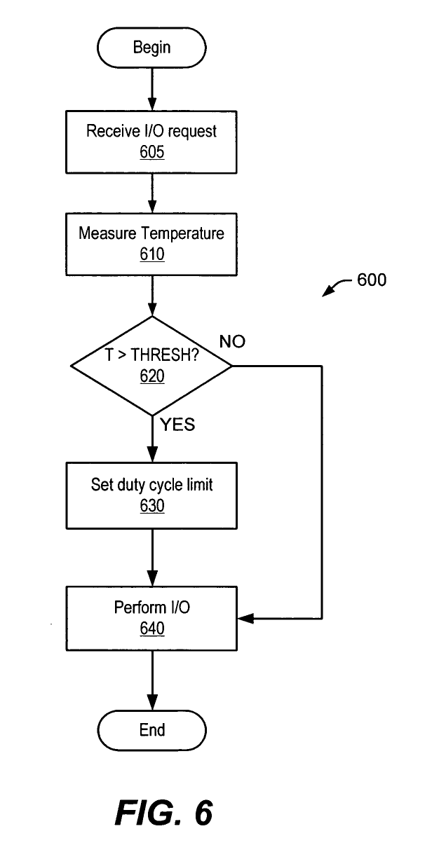

Operations 600 according to embodiments of the invention are illustrated in the flowchart of FIG. 6. With reference to FIGS. 1-6, when an I/O request is received by the disk drive 25 (block 605), a temperature associated with the disk drive 25 is measured (block 610). The measured temperature may include, for example, the temperature within the case of the disk drive, the ambient temperature of the environment in which the disk drive is operated, a temperature sensed at the PCBA, and/or the temperature of a component of the disk drive, such as the read/write head 32 or any combination thereof. In some embodiments, a temperature differential between the measured temperature and the actual temperature of the read/write transducer 32 may be estimated, to thereby obtain an estimated temperature of the read/write transducer 32. For example a typical absolute or percentage temperature differential between the measured temperature and the actual temperature of the read/write transducer 32 may be determined empirically and may be used to estimate the actual temperature of the read/write transducer 32 from the measured temperature. In some embodiments, the measured temperature may be taken as the estimated temperature of the read/write transducer 32. The temperature used for regulating an I/O operation according to embodiments of the invention may be a measured temperature or an estimated temperature.

The temperature (measured or estimated) is compared to a selected temperature threshold THRESH (block 620). If the temperature exceeds the threshold, a duty cycle limit for an I/O operation, such as a write operation and/or a read operation, is set. The I/O operation is then performed (block 640) subject to the duty cycle limit set in block 630, if any. If the temperature does not exceed the threshold, the I/O operation may be performed without a duty cycle limit set in response to the temperature measurement. The duty cycle limit may in some embodiments be a single, fixed limit that is implemented when the temperature exceeds a selected threshold value.

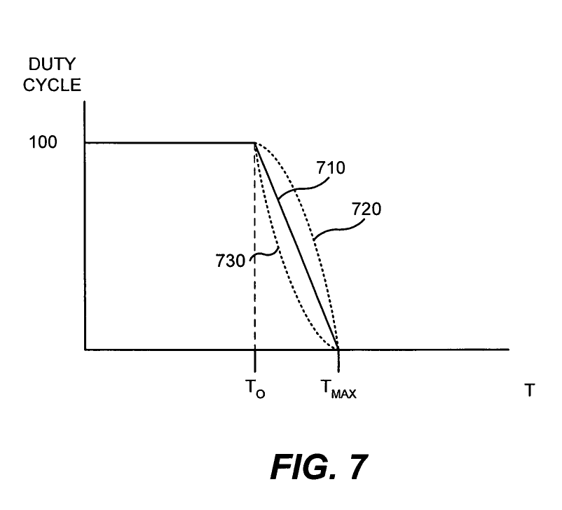

In other embodiments, however, the duty cycle limit may be calculated as a function of temperature. For example, the duty cycle limit may be calculated according to a function illustrated as curve 710 in FIG. 7, which is a graph of duty cycle versus measured temperature (T). As shown therein, the duty cycle would be 100% up to an initial threshold temperature T₀. From the threshold temperature T₀ up to a maximum temperature T_{MAX}, the selected duty cycle would decrease as a function of temperature until the duty cycle reached 0%, at which time the disk drive would effectively be shut down until the temperature decreased.

It will be appreciated that while a linear relationship between duty cycle and temperature is illustrated in curve 710, the relationship may be nonlinear in some embodiments. For example, the duty cycle may decrease more slowly at temperatures closer to the initial threshold temperature T₀ and more quickly as temperature increases (e.g. curve 720), or vice versa (curve 730). Other relationships between duty cycle and measured temperature are possible. For example, the rate of change of duty cycle vs. temperature may not be symmetric. The duty cycle may decrease more quickly as temperature rises than it increases as temperature drops. The controller may also be configured to adjust the duty cycle as a function of the duration of the I/O operation. For example, the controller may decrease the duty cycle as the length of the I/O operation increases.

Embodiments of the invention, which may be used in any disk drive application that may encounter increased ambient temperatures, may reduce the occurrence of pole tip protrusion that may result in collisions between the read/write head 32 and the disk 30, which may reduce data loss and/or damage to the read/write heads 32 and/or the disk media. Embodiments of the invention may be particularly useful for temporarily operating the disk drive 25 in environments that exceed the nominal operating temperature specification for the disk drive 25. In fact, some embodiments of the invention may allow a disk drive 25 to continue to operate at temperatures outside the specified operating limits, in a way that allows access to user data while reducing the potential for damage associated with those accesses. The ability for a disk drive to operate, at least temporarily, at temperatures outside the specified operating limits may be important for mission-critical operations. Furthermore, embodiments of the invention may be particularly suited for reducing PTP-induced collisions during long I/O operations that may not be effectively limited at the command queue level.

According to some embodiments of the invention, a disk drive may be configured to have a set of discrete duty cycle limits that may be invoked when corresponding temperature limits are reached. For example, as illustrated in Table 1, a disk drive may be configured to have an initial temperature threshold of 65° C., at which point a duty cycle limit of 60% is invoked. The disk drive may have additional progressively stricter duty cycle limits that are invoked as higher temperature thresholds are reached, up to, for example, a 10% duty cycle limit if the temperature exceeds 90° C.

TABLE 1
Sample Thresholds and Corresponding Duty Cycle Limits

| Threshold | Duty Cycle |
|---|---|
| (° C.) | Limit (%) |
| 65 | 60 |
| 70 | 50 |
| 75 | 40 |
| 80 | 30 |
| 85 | 20 |
| 90 | 10 |

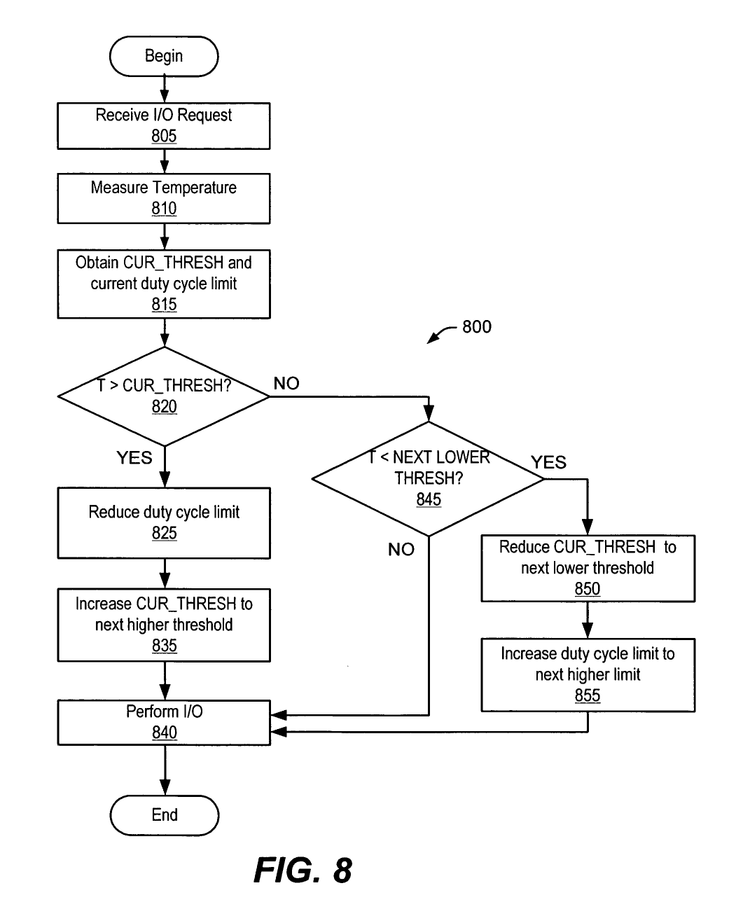

Operations according to embodiments of the invention in which multiple thresholds and duty cycle limits are illustrated in the flowchart of FIG. 8. As shown therein, when an I/O request is received by the disk drive 25 (block 805), a temperature associated with the disk drive 25 is measured (block 810). The temperature may include, for example, the temperature within the case of the disk drive, the ambient temperature of the environment in which the disk drive is operated, a temperature sensed at the PCBA, and/or the temperature of a component of the disk drive, such as the read/write head 32. The disk drive electronics are configured to store in memory a current threshold CUR_THRESH, which may be a default value and/or which may have been set in an earlier iteration of the control loop 800 illustrated in FIG. 8, and a current duty cycle limit.

The current threshold CUR_THRESH and duty cycle limit are retrieved (block 815), and the temperature T is compared to the current threshold CUR_THRESH (block 820). If the temperature T is greater than the current threshold CUR_THRESH, then the duty cycle limit is reduced to the duty cycle limit associated with the current threshold level (block 825), while the threshold is reset to the next higher threshold level (block 835). The I/O operation is then performed subject to the reduced duty cycle limit (block 840).

If, in block 820, the temperature does not exceed the current threshold, the temperature T is compared to the next threshold lower than the current threshold (block 845). If the temperature is not less than the next lower threshold, control passes to block 840, and the I/O operation is performed subject to the current duty cycle limit. If, however, the temperature T is determined at block 845 to be less than the next lower threshold, the current threshold may be reduced to the next lower threshold (block 850), and the duty cycle limit may be increased to the next higher duty cycle limit (block 855). The I/O operation is then performed subject to the new, higher, duty cycle limit (block 840).

The following example is provided as an illustration of operations according to the embodiments of FIG. 8 using the set of thresholds and associated duty cycle limits shown in Table 1. In the example, a temperature associated with a disk drive is measured prior to each of a series of I/O operations labeled 101 through 106, as shown in Table 2. The I/O operations 101 through IO6 need not be immediately sequential, but may, for example, be the next I/O operations following regularly or irregularly performed temperature measurements.

TABLE 2
Sample Temperature Measurements and Resulting Thresholds
and Duty Cycle Limits

| | | Current | Current Duty | New | New Duty |
|---|---|---|---|---|---|
| | Temperature | Threshold | Cycle Limit | Threshold | Cycle Limit |
| I/O | (° C.) | (° C.) | (%) | (° C.) | (%) |
| IO1 | 68 | 65 | 100 | 70 | 60 |
| IO2 | 72 | 70 | 60 | 75 | 50 |
| IO3 | 78 | 75 | 50 | 80 | 40 |
| IO4 | 78 | 80 | 40 | 80 | 40 |
| IO5 | 72 | 80 | 40 | 75 | 50 |
| IO6 | 64 | 75 | 50 | 70 | 60 |
| IO7 | 64 | 70 | 60 | 65 | 100 |

Before I/O operation IO1 is initiated, the current threshold CUR_THRESH is assumed to be the initial threshold level of 65, while the current duty cycle limit is 100% (i.e. unlimited). Before the first I/O operation IO1 is performed, the disk drive electronics measures the temperature associated with the disk drive at 68° C. As the temperature exceeds the current threshold of 65° C., the threshold is increased to a new threshold of 70° C. and the duty cycle limit is reduced to 60%. The first I/O operation IO1 is then performed subject to a duty cycle limit of 60%.

When the second I/O operation IO2 is initiated, the current threshold is 70° C. and the current duty cycle limit is 60%. The temperature is again measured, and in this example is 72° C. when the second I/O operation IO2 is initiated. As the temperature exceeds the current threshold of 70° C., the threshold is increased to a new threshold of 75° C. and the duty cycle limit is reduced to 50%. The second I/O operation IO2 is then performed subject to a duty cycle limit of 50%.

Similarly, when the third I/O operation IO3 is initiated, the current threshold is now 75° C. and the current duty cycle limit is 50%. The temperature is again measured, and in this example is 78° C. when the third I/O operation IO3 is initiated. As the temperature exceeds the current threshold of 75° C., the threshold is increased to a new threshold of 80° C. and the duty cycle limit is reduced to 40%. The third I/O operation IO3 is then performed subject to a duty cycle limit of 40%.

Thus, when the fourth I/O operation IO4 is initiated, the current threshold is 80° C. and the duty cycle limit is 40%. However, the temperature is again measured at 78° C., which does not exceed the current threshold of 80° C. Thus, the temperature is compared against the next lower threshold (75° C.). Since the temperature is not less than the next lower threshold, the fourth I/O operation IO4 is performed with the current duty cycle limit of 40%, and neither the duty cycle limit nor the threshold temperature is changed.

Since the duty cycle limit and threshold temperature do not change in connection with I/O operation IO4, the current duty cycle limit and threshold temperature remain at 40% and 80° C., respectively, when the fifth I/O operation IO5 is initiated. In this case, the temperature is 72° C., which is lower than both the current threshold of 80° C. as well as the next lower threshold of 75° C. Thus, the current threshold level is reduced to the next lower threshold of 75° C., while the duty cycle limit is increased to the next higher limit of 50%, and the fifth I/O operation IO5 is performed subject to the new duty cycle limit of 50%.

When the sixth I/0 operation IO6 is initiated, the current threshold is 75° C., while the duty cycle limit is 50%. The temperature when the sixth I/O operation IO6 is initiated is 64° C., which is lower than both the current threshold of 75° C. as well as the next lower threshold of 70° C. Thus, the current threshold level is reduced to the next lower threshold of 70° C., while the duty cycle limit is increased to the next higher limit of 60%, and the sixth I/O operation IO6 is performed subject to the new duty cycle limit.

Finally, when the seventh I/O operation IO7 is initiated, the temperature is again measured at 64° C., which is lower than both the current threshold of 70° C. as well as the next lower threshold of 65° C. Thus, the current threshold level is reduced to the next lower threshold of 65° C., while the duty cycle limit is increased to the next higher limit of 100%. The seventh I/O operation Io7 is thus performed with no duty cycle limit.

It will be appreciated that the algorithms described above and in connection with FIG. 8 may be modified to suit particular system performance needs. For example, the algorithms could be modified to decrease the duty cycle limit further if a temperature exceeds both a current threshold level as well as a next higher threshold level. Furthermore, the algorithms may be modified such that the duty cycle limits and/or the temperature thresholds could be increased and/or decreased by more than one step in each iteration.

In the drawings and specification, there have been disclosed typical preferred embodiments of the invention and; although specific terms are employed, they are used in a generic and descriptive sense only and not for purposes of limitation, the scope of the invention being set forth in the following claims.

What is claimed is:

1. A method of regulating an I/O operation of a disk drive, the method comprising:
determining a temperature associated with the disk drive;
comparing the determined temperature to a temperature threshold;
setting a duty cycle limit for the I/O operation in response to the determined temperature exceeding the temperature threshold; and
performing the I/O operation subject to the duty cycle limit.

2. The method of claim 1, wherein setting the duty cycle limit comprises setting the duty cycle limit to a value associated with the temperature threshold.

3. The method of claim 1, wherein setting the duty cycle limit comprises setting the duty cycle limit to a value based on the amount by which the determined temperature exceeds the temperature threshold.

4. The method of claim 1, wherein the I/O operation comprises a data write operation.

5. The method of claim 1, wherein the I/O operation comprises a data read operation.

6. The method of claim 1, wherein setting the duty cycle limit for the I/O operation comprises decreasing a duty cycle limit in response to the determined temperature exceeding the temperature threshold.

7. The method of claim 6, wherein the determined temperature comprises a first temperature, the method further comprising:
after performing the I/O operation, detecting a second temperature associated with the disk drive; and
increasing the duty cycle limit in response to the second temperature being less than the temperature threshold.

8. The method of claim 1, wherein performing the I/O operation using the duty cycle limit comprises performing the I/O operation using a transducer for a first number of wedges; and then
resting the transducer for a second number of wedges.

9. The method of claim 1, wherein determining the temperature associated with the disk drive comprises measuring the temperature associated with the disk drive and/or estimating the temperature associated with the disk drive.

10. The method of claim 9, wherein the second number of wedges is varied in response to the comparison.

11. The method of claim 1, wherein performing the I/O operation using the duty cycle limit comprises performing the I/O operation using a transducer for a first period of time; and then
resting the transducer for a second period of time.

12. The method of claim 1, wherein the temperature threshold comprises a first temperature threshold, the method further comprising:
comparing the determined temperature to a second temperature threshold in response to the determined temperature being less than the first temperature threshold.

13. The method of claim 12, wherein the second temperature threshold is less than or equal to a next lower temperature threshold of a plurality of temperature thresholds including the first temperature threshold , the method further comprising reducing the temperature threshold to the next lower temperature threshold in response to the determined temperature being less than the second temperature threshold.

14. The method of claim 12, further comprising increasing the duty cycle limit in response to the determined temperature being less than the second temperature threshold.

15. The method of claim 1, wherein determining the temperature associated with the disk drive comprises measuring a temperature using a temperature sensor and estimating a temperature differential between the measured temperature and an actual temperature of a read/write transducer in the disk drive.

16. A disk drive, comprising:
a temperature sensor configured to measure a temperature associated with the disk drive; and
a controller coupled to the temperature sensor and configured to determine a temperature of a transducer of the disk drive in response to the measured temperature, to compare the determined temperature to a temperature threshold, to set a duty cycle limit for an I/O operation in response to the determined temperature exceeding the temperature threshold, and to perform the I/O operation subject to the duty cycle limit.

17. The disk drive of claim 16, wherein the controller is further configured to set the duty cycle limit to a value associated with the temperature threshold.

18. The disk drive of claim 16, wherein the controller is further configured to set the duty cycle limit to a value based on the amount by which the determined temperature exceeds the temperature threshold.

19. The disk drive of claim 16, wherein the controller is further configured to decrease the duty cycle limit in response to the determined temperature exceeding the temperature threshold.

20. The disk drive of claim 19, wherein the determined temperature comprises a first temperature, and wherein the controller is further configured to, after performing the I/O operation, determine a second temperature associated with the disk drive, and to increase the duty cycle limit in response to the second temperature being less than the temperature threshold.

21. The disk drive of claim 16, wherein the controller is further configured to perform the I/O operation using the transducer for a first number of wedges, and then to rest the transducer for a second number of wedges.

22. The disk drive of claim 21, wherein the controller is further configured to vary the second number of wedges in response to the comparison.

23. The disk drive of claim 16, wherein the controller is further configured to estimate a temperature differential between the measured temperature and an actual temperature of the transducer, to obtain the determined temperature of the transducer.

24. The disk drive of claim 16, wherein the controller is further configured to perform the I/O operation using the transducer for a first period of time, and then to rest the transducer for a second period of time.

25. The disk drive of claim 16, wherein the controller is further configured to compare the determined temperature to a next lower temperature threshold in response to the determined temperature being less than the threshold temperature.

26. The disk drive of claim 25, wherein the controller is further configured to reduce the threshold temperature to the next lower threshold temperature in response to the determined temperature being less than the next lower threshold temperature.

27. The disk drive of claim 26, wherein the controller is further configured to increase the duty cycle limit in response to the determined temperature being less than the next lower threshold temperature.

28. The disk drive of claim 16, wherein the controller is configured to adjust the duty cycle limit as a function of the duration of the I/O operation.

29. The disk drive of claim 28, wherein the controller is configured to decrease the duty cycle limit as the length of the I/O operation increases.
